(19) United States
(12) Patent Application Publication
(10) Pub. No.: US 2016/0191309 A1
(43) Pub. Date: Jun. 30, 2016

(54) CLOUD SYSTEM CONFIGURATION METHOD, SERVER AND DEVICE

(71) Applicants: Beijing Lenovo Software Ltd., Beijing (CN); Lenovo (Beijing) Limited, Beijing (CN)

(72) Inventors: Jie Yang, Beijing (CN); Zhan Gao, Beijing (CN); Jun Liu, Beijing (CN); Liangliang Ma, Beijing (CN); Xiaolei Han, Beijing (CN)

(21) Appl. No.: 14/659,783

(22) Filed: Mar. 17, 2015

(30) Foreign Application Priority Data
Dec. 29, 2014 (CN) 201410849181.5

(51) Int. Cl. H04L 12/24; H04L 29/08; H04L 29/12

(52) U.S. Cl. CPC H04L 41/0806; H04L 61/2007; H04L 67/10

(57) ABSTRACT

The present disclosure provides a cloud system configuration method which can simplify and reduce manual manipulations involved in building of a private cloud. The method comprises: collecting dynamic information of a server in a cloud system by an automatic configuration module installed in the server, upon the cloud system has been built and the server is powered up for the first time, wherein the dynamic information includes at least an Internet protocol IP address of the server, and the cloud system includes M servers and N switches, M, N being positive integers; configuring, by the automatic configuration module, the server according to the dynamic information, so that the server implements corresponding functions according to the configuration. The present disclosure also discloses another cloud system configuration method, a server in the cloud system and an apparatus for configuring the cloud system.

### CROSS-REFERENCE TO RELATED APPLICATION(S)

This application the benefit under 35 U.S.C. 119 to Chinese Application No. 201410849181.5, filed on Dec. 29, 2014, which application is incorporated herein by reference in its entirety.

### TECHNICAL FIELD

The present disclosure relates to a field of cloud service technology, and in particular, to a cloud system configuration method, a server and a device using the same.

### RELATED ART

Cloud services may be used for uploading software and hardware, materials etc. as required by an enterprise to the Internet, and may provide interconnections using different IT (Information Technology) devices at all times and places, in order to realize data access, operation and other purposes. Currently, there are two kinds of common cloud services, i.e., a public cloud and a private cloud.

In recent years, the economic environment is more and more competitive. Cost saving is considered by even large enterprises, and thus the demand for the cloud service increases. Although public cloud service providers have to comply with industry regulations, it is impossible for large enterprises (such as those in finance, insurance etc.) to store important data in the public network in order to protect privacies of both industry and customers. Therefore, such large enterprises may prefer to construct a private cloud network, i.e., prefer to build a private cloud.

Nowadays, a commonly used approach of building the private cloud by the enterprise comprises purchasing hardware and software respectively (e.g., firstly collecting hardware devices as required, then selecting software configurations matched with the collected hardware devices after the collecting is completed); and completing installation of the private cloud for the enterprise by a software configuration provider. During the software installation, a user typically installs the software manually, which is obviously a relatively complicated operation for the user.

### SUMMARY

In a first aspect of the present disclosure, a cloud system configuration method is provided. The method comprises: collecting dynamic information of a server in the cloud system by an automatic configuration module installed in the server, upon the cloud system has been built and the server is powered up for the first time, wherein the dynamic information includes at least an Internet protocol, IP, address of the server; and configuring, by the automatic configuration module, the server according to the collected dynamic information, so that the server implements corresponding functions as configured.

In an embodiment of the present disclosure, the server is a management server. And the step of configuring the server according to the collected dynamic information comprises: determining a host name of the management server and network information of a network where the management server is located, according to the collected dynamic information; and, configuring related information for the management server implementing a function of managing the cloud system.

In an embodiment of the present disclosure, the server is a computing server. And the step of configuring the server according to the collected dynamic information comprises: determining a host name of the computing server and network information of a network where the computing server is located, according to the collected dynamic information; and, configuring related information for the computing server implementing a computing function in the cloud system.

In an embodiment of the present disclosure, the server is a storage server. And the step of configuring the server according to the collected dynamic information comprises: determining a host name of the storage server and network information of a network where the storage server is located, according to the collected dynamic information; and, configuring related information for the storage server implementing a storage function in the cloud system.

In an embodiment of the present disclosure, the server is a management server. And the method further comprises: after the dynamic information of the server is collected by the automatic configuration module in the server, setting, by the automatic configuration module, a control logic required by the management server for controlling N switches comprised in the cloud system, wherein N is a positive integer; generating rule files which are required by the N switches; and, distributing the generated rule files to respective ones of the N switches, wherein the respective switches operate according to the respective rule files received.

In a second aspect of the present disclosure, a cloud system configuration method is provided. The method comprises: receiving a request from a user; determining, according to the received request, device information that is required for building the cloud system, wherein the device information includes information indicating numbers and/or types of devices required; determining at least M servers and N switches according to the determined device information, wherein M, N are positive integers; installing respective operating systems in the M servers respectively; and, installing respective automatic configuration modules in the M servers respectively according to different functions of the M servers, wherein the automatic configuration module is used to configure respective server to implement respective function of the respective server.

In an embodiment of the present disclosure, the step of determining M servers according to the determined device information comprises: determining i management servers, j computing servers and k storage servers according to the determined device information, in which both i and k are integers no less than 0, and j is a positive integer.

In an embodiment of the present disclosure, the method further comprises: constituting the cloud system by connecting the M servers and the N switches in a predetermined way, after respective automatic configuration modules are installed in the M servers respectively.

In a third aspect of the present disclosure, a server in a cloud system is provided. The server comprises: a processor and a memory containing instructions recorded thereon. When executed by the processor, the instructions causes the processor to perform processes of: collecting dynamic information of a server in the cloud system, upon the cloud system has been built and the server is powered up for the first time, wherein the dynamic information includes at least an Internet protocol, IP, address of the server; configuring the server according to the collected dynamic information, so that the server implements corresponding functions as configured.

In an embodiment of the present disclosure, the server is a management server. The process of configuring the server according to the collected dynamic information comprises: determining a host name of the management server and network information of a network where the management server is located, according to the collected dynamic information; and, configuring related information for the management server implementing a function of managing the cloud system.

In an embodiment of the present disclosure, the server is a computing server. The process of configuring the server according to the collected dynamic information comprises: determining a host name of the computing server and network information of a network where the computing server is located, according to the collected dynamic information; and, configuring related information for the computing server implementing a computing function in the cloud system.

In an embodiment of the present disclosure, the server is a storage server. The process of configuring the server according to the collected dynamic information comprises: determining a host name of the storage server and network information of a network where the storage server is located, according to the collected dynamic information; and, configuring related information for the storage server implementing a storage function in the cloud system.

In an embodiment of the present disclosure, the server is a management server. The memory contains further instructions recorded thereon, when executed by the processor, the further instructions causing the processor to perform processes of: setting a control logic required by the management server for controlling N switches comprised in the cloud system, wherein N is a positive integer; generating rule files which are required by the N switches; and, distributing the generated rule files to respective ones of the N switches, wherein the respective switches operate according to the respective rule files received.

In a fourth aspect of the present disclosure, a computer-implemented apparatus for configuring a cloud system is disclosed. The apparatus comprises: a processor and a memory containing instructions recorded thereon. When executed by the processor, the instructions causes the processor to perform processes of: receiving a request from a user; determining, according to the received request, device information that is required for building the cloud system, wherein the device information includes information indicating numbers and/or types of devices required; determining at least M servers and N switches according to the determined device information, wherein M, N are positive integers; installing respective operating systems in the M servers respectively; and, installing respective automatic configuration modules in the M servers respectively according to different functions of the M servers, wherein the automatic configuration module is used to configure respective server to implement respective function of the respective server.

In an embodiment of the present disclosure, the process of determining M servers according to the determined device information comprises: determining i management servers, j computing servers and k storage servers according to the determined device information, in which both i and k are integers no less than 0, and j is a positive integer.

In an embodiment of the present disclosure, the memory contains further instructions recorded thereon, when executed by the processor, the further instructions causing the processor to perform a process of: constituting the cloud system by connecting the M servers and the N switches in a predetermined way, after respective automatic configuration modules are installed in the M servers respectively.

### BRIEF DESCRIPTION OF THE DRAWINGS

FIG. 1 illustrates an exemplary flowchart of a first kind of cloud system configuration method in an embodiment of the present disclosure;

FIG. 2 illustrates an exemplary flowchart of a second kind of cloud system configuration method in an embodiment of the present disclosure;

FIG. 3 illustrates an block diagram of an automatic configuration module in a server according to an embodiment of the present disclosure; and

FIG. 4 illustrates a block diagram of a cloud system configuration apparatus corresponding to the second kind of cloud system configuration method in an embodiment of the present disclosure.

### DETAILED DESCRIPTION OF THE EMBODIMENTS

In order to solve the technical problem with the conventional technical solutions, embodiments of the present disclosure provide a cloud system configuration method and a server, which can simplify and reduce manual manipulations involved in building of a private cloud.

An embodiment of the present disclosure provides a cloud system configuration method, comprising: collecting dynamic information of a server in a cloud system by an automatic configuration module installed in the server, upon the cloud system has been built and the server is powered up for the first time, wherein the dynamic information includes at least an Internet protocol, IP, address of the server, and wherein the cloud system includes M servers and N switches, M, N being positive integers; configuring, by the automatic configuration module, the server according to the dynamic information, so that the server implements corresponding functions according to the configuration.

In the embodiment of the present disclosure, upon the cloud system has been built and the server included in the cloud system is powered up for the first time, the automatic configuration module installed in the server may automatically collect the dynamic information of the server, e.g. information of the network where the server is located and etc., and may automatically configure the server according to the collected information. After the configuration is done, the server may complete tasks which are required to be completed in the cloud system. As such, in the embodiment of the present disclosure, the configuration on the server may be implemented by the server itself without manual configuration of the user. As such, the embodiment of the present disclosure may avoid or simplify the operations of the user and improve intelligence of the cloud system.

Furthermore, in the conventional solution, a device is generally configured directly by the provider, and then is shipped to a customer site. Such a configuration process generally does not consider an actual situation of the environment where the server is to be located.

Thus, a problem may occur during the run time of the server due to a mismatch between the configuration of the server and the actual situation. On the contrary, in the embodiments of the present disclosure, the server is configured according to the collected dynamic information of the server, so as to enable the configuration result to better comply with the actual situation of the server better, and to facilitate the actual operations of the server.

The aims, technical solutions and advantages of the present invention will be more apparent, when making a referent to the following clear and comprehensive description of implementations of embodiments of the present invention in conjunction with the accompanying drawings. Obviously, the described embodiments are just a few of the embodiments of the present invention, but not all embodiments. Upon the teaching of the embodiments of the present disclosure, all of other embodiments obtained by those ordinary skilled in the art without creative effort are within the protection scope of the present invention.

Further, the term “and/or” herein is just used to describe the association relationships of contextual objects, which represents there may be three types of relationships. For example, A and/or B, may mean the following three cases: only A exists, both A and B exist, or only B exists. In addition, the character “I” as used herein represents an “or” relationship of contextual objects.

Hereinafter, preferred embodiments of the present disclosure will be described in detail in connection with the drawings.

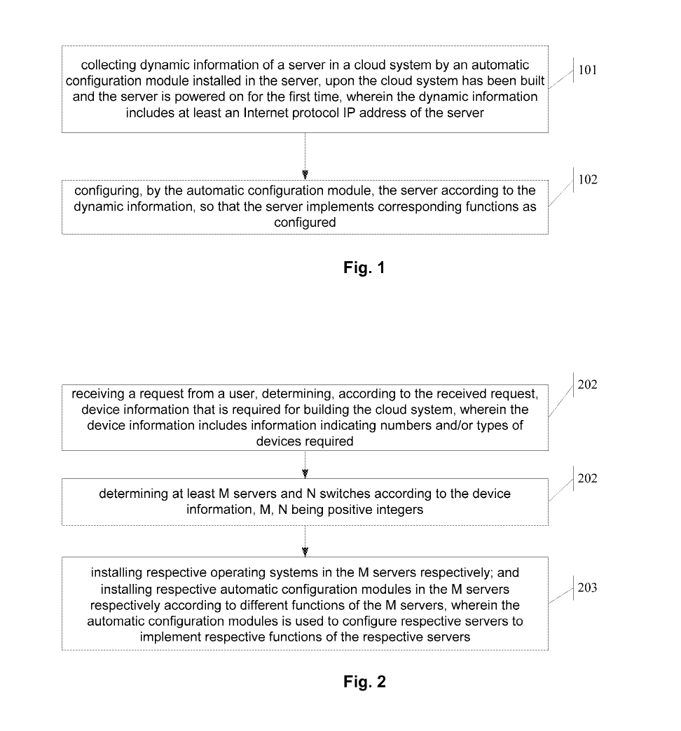

With reference to FIG. 1, an embodiment of the present disclosure provides a cloud system configuration method. The flowchart of the method may be described as below.

In step 101, upon a cloud system has been built and a server in the cloud system is powered up for the first time, dynamic information of the server is collected by an automatic configuration module installed in the server, wherein the dynamic information includes at least an Internet protocol, IP, address of the server, and the cloud system includes M servers and N switches, M, N being positive integers.

In the embodiment of the present disclosure, the cloud system generally refers to a private cloud system. The cloud system having been built means that the M servers and the N switches included in the cloud system have been connected and may operate normally.

In the embodiment of the present disclosure, before the step 101, the method further comprises a process of building the cloud system, which will be introduced as follows.

Firstly, the provider may provide the user with an input interface, by which the user may view different private cloud schemes provided by the provider for the user. For example, one private cloud scheme may include one management server (which may also be referred to as a management node), four computing servers (which may also be referred to as computing nodes), one storage server (which may also be referred to as a storage node) and eight switches. Of course, the above example is described only for illustration, but does not limit actual numbers of the respective servers. In addition, in the private cloud scheme provided by the provider, information regarding device types and some other information may also be included, besides particular numbers of the servers. For example, a private cloud scheme not only specifies respective numbers of respective servers, but also specifies models of respective servers. What are particularly included in the private cloud scheme as provided by the provider may be determined by the provider.

Furthermore, if the user does not find a desired private cloud scheme in the input interface, the user may further customize a private cloud scheme as required by using the input interface, i.e., the user may directly input, via the input interface, what private cloud scheme he requires. For example, one private cloud scheme input by the user may be a private cloud scheme including one management server (which may be referred to as a management node), two computing servers (which may be referred to as computing nodes), one storage server (which may be referred to as a storage node) and four switches. Again, in the private cloud scheme customized by the user, information regarding device types and some other information may be included besides particular number of the devices. For example, a private cloud scheme customized by the user further provisions types of respective servers, besides the respective numbers of the respective servers. What are particularly included in the private cloud scheme as customized by the user may be determined by the user.

After the user selects a certain private cloud scheme, or the user customizes a private cloud scheme, the system (which may be located at the provider at this time in the embodiment of the present disclosure) may receive a request message input by the user. Thus, the system may determine device information required for building the user-selected private cloud (or called as the cloud system), on the basis of the request message. The device information may include the numbers and/or types of devices being required. Of course, the device information may also include other possible information of the device.

After the system determines the device information, the system may determine at least M servers and N switches according to the device information, wherein M and N are positive integers. Besides the above information, the device information may further include other device information, e.g. information of cabinets for arranging the servers and the switches etc. The embodiment of the present disclosure puts no limitation on this regard.

After the devices, such as the M servers and the N switches, are determined, the provider may produce or purchase these devices.

After the devices have been produced or purchased, the system may install respective operating systems in each of the M servers. The M servers may comprise different types of servers, such as management servers, computing servers and storage servers etc. Then, the system may install respective automatic configuration modules in respective servers, according to respective types of individual servers. Functions implemented by the respective automatic configuration modules installed in the respective servers are different due to different types of the servers. In addition, the system may install some functional modules such as software and the like that are required by the respective servers in the respective servers. The present disclosure puts no limitation on this regard.

Then, the provider may delivery the devices to the customer. After the customer or the provider builds the cloud system by connecting these devices, the respective servers may be powered up. After the server is powered up, the automatic configuration module in each of the servers may collect dynamic information of the pertaining server, in order to complete the configuration of the server.

In step 102, the server is configured by the automatic configuration module according to the dynamic information, so that the server implements corresponding functions as configured. After configuration, the cloud system may operate normally.

Optionally, in the embodiment of the present disclosure, if the server is a management server, the step 102 of configuring the server according to the dynamic information comprises: determining a host name of the management server and network information of a network where the management server is located, according to the dynamic information; and configuring related information of the management server for implementing management of the cloud system.

For example, determining the host name of the management server and the network information of the network where the management server is located, according to the dynamic information comprises, but not limited to: establishing a mapping relationship between an IP address and a local host name of the management server (e.g., dynamically generating, in a line in a file such as/etc/hosts, the mapping relationship between the IP addresses and a local domain name according to the dynamically obtained IP address, in a Linux system (which is a kind of operating system)); establishing IP address configuration files for different network segments (a management network segment, a computing network segment and a storage network segment etc.); determining connection information for managing a database management system of the required server (e.g., dynamically replacing IP address information about database connection in the configuration file with a sed instruction (which is a kind of instruction)), etc.

For example, configuring the related information of the management server for implementing management of the cloud system comprises, but not limited to: enabling, in the management server, services required by the cloud system, e.g. including a cloud scheme management service, a switch configuration service, a database service, a monitoring service, a time synchronization service, a gateway service, and a storing file system client service, etc.

After configuration, the management service can manage the cloud system, and may complete tasks which are required to be completed by the management server.

Optionally, in the embodiment of the present disclosure, if the server is a computing server, the step 102 of configuring the server according to the dynamic information comprises: determining a host name of the computing server and network information of a network where the computing server is located, according to the dynamic information; and configuring related information of the computing server for implementing a computing function in the cloud system.

For example, determining the host name of the computing server and the network information of the network where the computing server is located according to the dynamic information comprises, but not limited to: establishing a local domain name resolution rule etc. according to the IP address.

For example, configuring the related information of the computing server for implementing the computing function in the cloud system comprises, but not limited to: configuring and enabling related services of the computing node (i.e., the computer server), e.g. including services of synchronization, monitoring client, storing file system client and virtualized management service (e.g., service libvirtd start) etc.

After configuration, the computing server can complete the computing task in the cloud system, i.e., completing tasks which are required to be completed by the computing server.

Optionally, in the embodiment of the present disclosure, if the server is a storage server, the step 102 of configuring the server according to the dynamic information comprises: determining a host name of the storage server and network information of a network where the storage server is located, according to the dynamic information; and configuring related information of the storage server for implementing a storage function in the cloud system.

For example, determining the host name of the storage server and the network information of the network where the storage server is located according to the dynamic information comprises, but not limited to: establishing the local domain name resolution rule etc. according to the IP address.

For example, configuring the related information of the storage server for implementing the storage function in the cloud system comprises, but not limited to: configuring and enabling related services of a storage node (i.e., the storage server), e.g., including services of synchronization, monitoring client and storing service process (e.g., /etc/init.d/ceph start osd) etc.

After configuration, the storage server can complete the storing task in the cloud system, i.e., completing tasks which are required to be completed by the storage server.

Further, in the embodiment of the present disclosure, if the server is a management server, after the dynamic information of the server is collected by the automatic configuration module in the server, the method may further comprise: setting, by the automatic configuration module, a control logic required by the management server for controlling the N switches; generating a rule file which is required for operations of the N switches; and distributing the generated rule file to a corresponding switch, wherein the rule file is used by the corresponding switch for operating according to the received rule file.

That is, the management server may further take charge of configuring the switch in the cloud system. Configuring the switch may comprise two aspects of content: one is setting a control logic required for controlling the switch by the management server, and the other is generating rule files required for operations of the N switches and distributing the generated rule files to respective switches. After the generated rule files are distributed to respective switches, the configuration of the switches in the cloud system is completed. The rule files received by different switches may be or may not be identical. After the switches receive the rule files, the switches may operate under the control of the management server according to the rule files.

With reference to FIG. 2, based on the same inventive idea, an embodiment of the present disclosure provides another cloud system configuration method. The flowchart of the method may be described as below.

In step 201, a request message transmitted by a user is received, and device information which is required for building the cloud system is determined according to the request message, wherein the device information includes the number and/or types of devices being required.

In step 202, at least M servers and N switches are determined according to the device information, wherein M, N are positive integers.

In step 203, operating systems are installed in each of the M servers, and respective automatic configuration modules are installed in each of the M servers according to respective functions of the M servers. The automatic configuration module is used for implementing configuration of the pertaining server so as to implement the function of the server.

In the step 202, determining M servers according to the device information comprises: determining i management servers, j computing servers and k storage servers according to the device information, in which both i and k are integers no less than 0, and j is a positive integer.

If both i and k equal to 0, and j equals to 1, the cloud system comprises only one server which may have all functions of management, computing and storage etc. simultaneously.

If i equals to 0, there is no dedicated management server in the cloud system, and the management function of the cloud system may be provided on the computing server.

If k equals to 0, there is no dedicated storage server in the cloud system, and the storage function of the cloud system may be provided on the computing server or on the management server of course.

Further, in the embodiment of the present disclosure, after the step 202, i.e., after the respective automatic configuration modules are installed in each of the M servers, the method further comprises: connecting the M servers and the N switches in a predetermined way, so that the M servers and the N switches constitute the cloud system.

That is, after these devices are shipped to the customer site, the provider or the customer may have these devices connected, so that these devices may constitute the cloud system. After these devices are connected and powered up for the first time, the automatic configuration module in each of the servers may be configured.

In the embodiment of the present disclosure, the step 201 is obviously automatically performed by the system, and the step 202 and the step 203 may either be automatically performed by the system, or be performed by the user manually. The present disclosure puts no limitation on this regard.

For example, if the step 202 is performed automatically, after the system determines the M servers and the N switches according to the device information, these devices may either be ordered and purchased autonomously, or be notified automatically to the provider for production. After these devices are available, the system may automatically install operating systems in each of the server, and may install respective automatic configuration modules.

In the embodiments of the present disclosure, the configuration illustrated in the flowchart of FIG. 2 is a basic configuration on the server in the cloud system, and the configuration illustrated in the flowchart of FIG. 1 is a final configuration on the server in the cloud system. That is, only if the configuration process in the flowchart of FIG. 2 is completed, the cloud system can operate normally.

In addition, the details involved in the flowchart of FIG. 2, which are not described in the description of the flowchart in FIG. 2, have been described in the flowchart of FIG. 1. Thus, the description of these details will be omitted here.

The embodiment of the present disclosure may provide the user with different private cloud schemes. In each of the schemes, different numbers of hardware devices (such as servers) may be included; or the user may request the hardware devices he needs, and the provider may, according to the user's request, purchase or produce the devices which are required by the cloud system as selected by the user, after the user's request is received. Furthermore, after the devices as required by the cloud system are ready, operating systems may be respectively installed in each of the servers, and different automatic configuration modules may be installed in different servers. As such, when the hardware devices have been connected subsequently, and the cloud system has been built, these servers may perform simply works by means of the operating system directly, and each of the servers may be further configured by the automatic configuration module, according to the dynamic information of the server, so that the server may complete the tasks in the cloud system. Equivalently, the user may only need to select a private cloud scheme, in order to provide the cloud system as required by the user, and software in the cloud system may be installed automatically without respectively purchasing hardware and software by the user. Obviously, the time for building the cloud system may be saved. Moreover, since the user only needs to perform a selecting operation and does not need to do more operations, the operation steps of the user may be simplified and the user experience may be improved.

With reference to FIG. 3, based on the same inventive idea, an embodiment of the present disclosure provides a server in which an automatic configuration module may be installed. The automatic configuration module may comprise a collection unit 301 and a first configuration unit 302.

The collection unit 301 is configured to collect dynamic information of the server in a cloud system by an automatic configuration module installed in the server, upon the cloud system has been built and the server is powered up for the first time. The dynamic information includes at least an Internet protocol, IP, address of the server, and the cloud system includes M servers and N switches, wherein M, N are positive integers.

The first configuration unit 302 is configured to configure the server according to the dynamic information, so that the server implements corresponding functions according to the configuration.

Optionally, in the embodiment of the present disclosure, if the server is a management server, the first configuration unit 302 is particularly configured to: determine a host name of the management server and network information of a network where the management server is located, according to the dynamic information; and to configure information of the management server for implementing a function of managing the cloud system.

Optionally, in the embodiment of the present disclosure, if the server is a computing server, the first configuration unit 302 is particularly configured to: determine a host name of the computing server and network information of a network where the computing server is located, according to the dynamic information; and to configure information of the computing server for implementing a computing function in the cloud system.

Optionally, in the embodiment of the present disclosure, if the server is a storage server, the first configuration unit 302 is particularly configured to: determine a host name of the storage server and network information of a network where the storage server is located, according to the dynamic information; and to configure information of the storage server for implementing a storage function in the cloud system.

Optionally, in the embodiment of the present disclosure, if the server is a management server, the automatic configuration module further comprises a second configuration unit.

The second configuration unit is configured to set a control logic required by the management server for controlling the N switches, after the dynamic information of the server is collected by the collection unit 301; to generate rule files which are required for operations of the N switches; and to distribute the generated rule files to respective switches, wherein the rule files are used by respective switches for operating according to the received rule file.

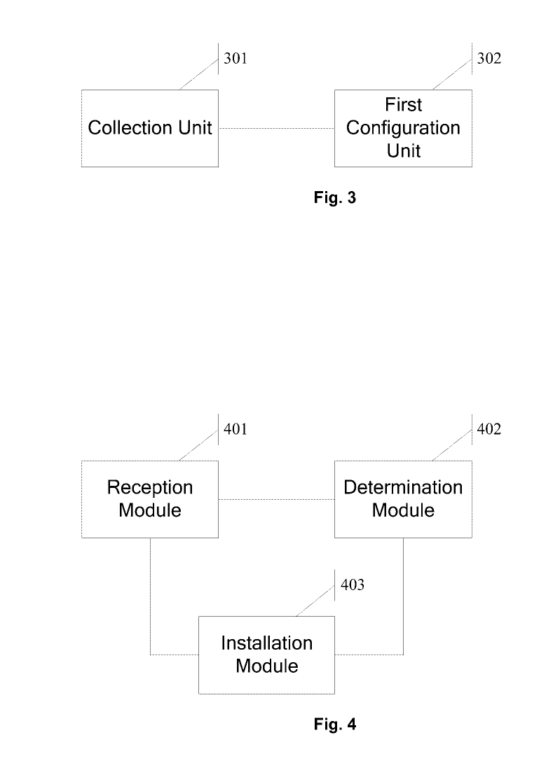

With reference to FIG. 4, based on the same inventive idea, an embodiment of the present disclosure provides a cloud system configuration apparatus, which may comprise a reception module 401, a determination module 402 and an installation module 403.

The reception module 401 is configured to receive a request message transmitted by a user, and to determine device information which is required for building the cloud system according to the request message, wherein the device information includes the numbers and/or types of devices being required.

The determination module 402 is configured to determine at least M servers and N switches according to the device information, wherein M, N are positive integers.

The installation module 403 is configured to install operating systems in each of the M servers, and installing respective automatic configuration modules in respective ones of the M servers according to different functions of the M servers, wherein the automatic configuration module is used for implementing configuration of respective server so as to implement the respective function of the respective server.

Optionally, in the embodiment of the present disclosure, the determination module 402 is particularly configured to determine i management servers, j computing servers and k storage servers according to the device information, in which both i and k are integers no less than 0, and j is a positive integer.

Optionally, in the embodiment of the present disclosure, the device further comprises: a connection module configured to connect the M servers and the N switches in a predetermined way, after respective automatic configuration modules are installed by the installation modules 403 in each of the M servers, so that the M servers and the N switches constitute the cloud system.

The embodiment of the present disclosure provides a cloud system configuration method, comprising: collecting dynamic information of a server in a cloud system by an automatic configuration module installed in the server, upon the cloud system has been built and the server is powered up for the first time, wherein the dynamic information includes at least an Internet protocol (IP) address of the server, and the cloud system includes M servers and N switches, M, N being positive integers; configuring, by the automatic configuration module, the server according to the dynamic information, so that the server implements corresponding functions according to the configuration.

In the embodiments of the present disclosure, upon the cloud system has been built and the server included in the cloud system is powered up for the first time, the automatic configuration module installed in the server may automatically collect the dynamic information, e.g. information of the network where the server is located etc., and may automatically configure the server according to the collected information. After configuration, the server may complete a task which is required to be completed by the server in the cloud system. Thus, in the embodiments of the present disclosure, the configuration on the server may be implemented by the server itself without manual configuration by the user. As such, the operations of the user may be simplified, and intelligence of the cloud system may be improved.

Furthermore, in the conventional solution, devices are generally configured by the provider directly, and then are supplied to a customer site. Such a configuration process generally may not take into account an actual situation of the environment where the server is located. Thus, a problem may occur during the run time of the server due to inconsistency between the configuration of the server and the actual situation it is located. On the contrary, in the embodiments of the present disclosure, the server is configured according to the collected dynamic information of the server, so as to enable the configuration result to comply with the actual situation of the server better, and to facilitate the actual operation of the server.

As may be clearly understood by the skilled in the art, divisions of the above functional modules are exemplarily described only for convenient and concise illustration. In practice, the above functional distributions may be implemented by different functional modules according to requirements, i.e., the internal structure of the device may be divided into different functional modules to implement all or parts of functions as described above. The particular operations of such a system, device and units may refer to corresponding processes in the method embodiments as described above. The description thereof will be omitted here.

It can be appreciated from the embodiments of the present application that the disclosed device and method can be implemented in alternative ways. The device embodiments as described above are illustrative only. For example, while the units have been divided in accordance with their logical functions, other divisions are possible in practice. For example, more than one unit or element can be combined or can be integrated into another system, or some features can be ignored or omitted. In addition, the coupling, direct coupling or communicative connection between various components as shown or discussed can be an indirect coupling or communicative connection via some interface, device or unit and can be electrical, mechanical or in another form.

The units described above as separated may or may not be physically separated. The components shown as units may or may not be physical units. They can be co-located or can be distributed over a number of network elements. Depending on actual requirements, some or all of the units can be selected to achieve the object of the present disclosure.

Further, all the functional units in various embodiments of the present disclosure can be integrated within one processing unit, or each of these units can be a separate unit, or two or more units can be integrated into one unit. Such integrated unit can be implemented in hardware, possibly in combination with software functional units.

If the integrated unit is implemented in a form of software function units and is sold or used as a separated product, the integrated unit may be stored in a computer readable storage medium. Based on such understanding, the technical solutions of the present disclosure may substantially, or parts contributing to the prior art or all or parts of the technical solutions may be partly embodied in a form of a software product. The computer software product is stored in storage medium, comprising several instructions so that all or parts of steps of the methods according to the embodiments of the present disclosure may be executed by a computer device (which may be a personal computer, a server or a network device etc.) or a processor. The above storage medium comprises various media capable of storing program codes, such as a U-disk, a mobile hard disk, a read-only memory (ROM), a random access memory (RAM), a magnetic disc or an optical disc and the like.

In particular, computer program instructions corresponding to a cloud system configuration method in the embodiments of the present disclosure may be stored in a storage medium, such as the optical disc, the hard disk, the U-disc. When the computer program instructions in the storage medium corresponding to the cloud system configuration method are read or executed by an electronic device, it causes the electronic device to perform a process comprising:

collecting dynamic information of a server in a cloud system by an automatic configuration module installed in the server, upon the cloud system has been built and the server is powered up for the first time, wherein the dynamic information includes at least an Internet protocol IP address of the server, and the cloud system includes M servers and N switches, M, N being positive integers;

configuring, by the automatic configuration module, the server according to the dynamic information, so that the server implements corresponding functions according to the configuration.

Optionally, the server is a management server; during the computer program instructions stored in the storage medium, corresponding to the step of configuring the server according to the dynamic information, are executed, the process particularly comprises:

determining a host name of the management server and network information of a network where the management server is located, according to the dynamic information; and configuring information of the management server for implementing a function of managing the cloud system.

Optionally, the server is a computing server; during the computer program instructions stored in the storage medium, corresponding to the step of configuring the server according to the dynamic information, are executed, the process particularly comprises: determining a host name of the computing server and network information of a network where the computing server is located, according to the dynamic information; and configuring information of the computing server for implementing a computing function in the cloud system.

Optionally, the server is a storage server; during the computer program instructions stored in the storage medium, corresponding to the step of configuring the server according to the dynamic information, are executed, the process particularly comprises: determining a host name of the storage server and network information of a network where the storage server is located, according to the dynamic information; and configuring information of the storage server for implementing a storage function in the cloud system.

Optionally, the server is a management server; after the computer program instructions stored in the storage medium, corresponding to the step of collecting the dynamic information of the server by the automatic configuration module in the server, are executed, the process further comprises: setting, by the automatic configuration module, a control logic required by the management server for controlling the N switches; generating rule files which are required for operations of the N switches; and distributing the generated rule files to respective switches, wherein the rule files are used by respective switches for operating according to the received rule files.

In particular, computer program instructions corresponding to another cloud system configuration method in the embodiments of the present disclosure may be stored in the storage medium, such as the optical disc, the hard disk, the U-disc. When the computer program instructions in the storage medium corresponding to the other cloud system configuration method are read or executed by an electronic device, a process comprises:

receiving a request message transmitted by a user, and determining device information which is required for building the cloud system according to the request message, wherein the device information includes the number and/or types of devices being required;

determining at least M servers and N switches according to the device information, M, N being positive integers;

installing operating systems in each of the M servers, and installing respective automatic configuration modules in each of the M servers according to different functions of the M servers, the automatic configuration module being used for implementing configuration of respective server by the respective automatic configuration module so as to implement the function of the respective server.

Optionally, during the computer program instructions stored in the storage medium, corresponding to the step of determining M server according to the device information, are executed, the process particularly comprises: determining i management servers, j computing servers and k storage servers according to the device information, in which both i and k are integers no less than 0, and j is a positive integer.

Optionally, after the computer program instructions stored in the storage medium, corresponding to the step of installing the corresponding automatic configuration module in each of the M servers, are executed, the process further comprises: connecting the M servers and the N switches in a predetermined way, so that the M servers and the N switches constitute the cloud system.

While the embodiments of the present disclosure have been described above, the scope of the present disclosure is not limited thereto. Various modifications and alternatives can be made by those skilled in the art without departing from the scope of the present disclosure. These modifications and alternatives are to be encompassed by the scope of the present disclosure which is only defined by the claims as attached.

What is claimed is:

1. A cloud system configuration method, comprising:
collecting dynamic information of a server in the cloud system by an automatic configuration module installed in the server, upon the cloud system has been built and the server is powered up for the first time, wherein the dynamic information includes at least an Internet protocol, IP, address of the server;
configuring, by the automatic configuration module, the server according to the collected dynamic information, so that the server implements corresponding functions as configured.

2. The method according to claim 1, wherein, the server is a management server, and the step of configuring the server according to the collected dynamic information comprises:
determining a host name of the management server and network information of a network where the management server is located, according to the collected dynamic information; and
configuring related information for the management server implementing a function of managing the cloud system.

3. The method according to claim 1, wherein, the server is a computing server, and the step of configuring the server according to the collected dynamic information comprises:
determining a host name of the computing server and network information of a network where the computing server is located, according to the collected dynamic information; and
configuring related information for the computing server implementing a computing function in the cloud system.

4. The method according to claim 1, wherein, the server is a storage server, and the step of configuring the server according to the collected dynamic information comprises:
determining a host name of the storage server and network information of a network where the storage server is located, according to the collected dynamic information; and
configuring related information for the storage server implementing a storage function in the cloud system.

5. The method according to claim 1, wherein the server is a management server, and the method further comprises: after the dynamic information of the server is collected by the automatic configuration module in the server,
setting, by the automatic configuration module, a control logic required by the management server for controlling N switches comprised in the cloud system, wherein N is a positive integer;
generating rule files which are required by the N switches; and
distributing the generated rule files to respective ones of the N switches,
wherein the respective switches operate according to the respective rule files received.

6. A cloud system configuration method, comprising:
receiving a request from a user;
determining, according to the received request, device information that is required for building the cloud system, wherein the device information includes information indicating numbers and/or types of devices required;
determining at least M servers and N switches according to the determined device information, wherein M, N are positive integers;
installing respective operating systems in the M servers respectively; and
installing respective automatic configuration modules in the M servers respectively according to different functions of the M servers, wherein the automatic configuration module is used to configure respective server to implement respective function of the respective server.

7. The method according to claim 6, wherein the step of determining M servers according to the determined device information comprises:
determining i management servers, j computing servers and k storage servers according to the determined device information, in which both i and k are integers no less than 0, and j is a positive integer.

8. The method according to claim 6, further comprising:
constituting the cloud system by connecting the M servers and the N switches in a predetermined way, after respective automatic configuration modules are installed in the M servers respectively.

9. A server in a cloud system, the server comprising:
a processor, and
a memory containing instructions recorded thereon, when executed by the processor, the instructions causing the processor to perform processes of:
collecting dynamic information of a server in the cloud system, upon the cloud system has been built and the server is powered up for the first time, wherein the dynamic information includes at least an Internet protocol, IP, address of the server;
configuring the server according to the collected dynamic information, so that the server implements corresponding functions as configured.

10. The server according to claim 9, wherein the server is a management server, and the process of configuring the server according to the collected dynamic information comprises:
determining a host name of the management server and network information of a network where the management server is located, according to the collected dynamic information; and
configuring related information for the management server implementing a function of managing the cloud system.

11. The server according to claim 9, wherein the server is a computing server, and the process of configuring the server according to the collected dynamic information comprises:
determining a host name of the computing server and network information of a network where the computing server is located, according to the collected dynamic information; and
configuring related information for the computing server implementing a computing function in the cloud system.

12. The server according to claim 9, wherein the server is a storage server, and the process of configuring the server according to the collected dynamic information comprises:
determining a host name of the storage server and network information of a network where the storage server is located, according to the collected dynamic information; and
configuring related information for the storage server implementing a storage function in the cloud system.

13. The server according to claim 9, wherein the server is a management server, and the memory contains further instructions recorded thereon, when executed by the processor, the further instructions causing the processor to perform processes of:
setting a control logic required by the management server for controlling N switches comprised in the cloud system, wherein N is a positive integer;
generating rule files which are required by the N switches; and
distributing the generated rule files to respective ones of the N switches, wherein the respective switches operate according to the respective rule files received.
